(19) United States
(12) Patent Application Publication
(10) Pub. No.: US 2016/0293045 A1
(43) Pub. Date: Oct. 6, 2016

(54) VOCABULARY LEARNING SUPPORT SYSTEM

(71) Applicant: FUJITSU LIMITED, Kawasaki-shi (JP)

(72) Inventors: Jun WANG, San Jose, CA (US); Kanji UCHINO, San Jose, CA (US)

(21) Appl. No.: 14/675,509

(22) Filed: Mar. 31, 2015

(51) Int. Cl. G09B 19/04

(52) U.S. Cl. CPC G09B 19/04

(57) ABSTRACT

A method to build a learner's vocabulary includes accessing a personal vocabulary profile of the learner that includes one or more unstable terms being learned by the learner and one or more stable terms that have been mastered by the learner. The method also includes marking a term in an electronic document output to a display device as an unstable term in response to the term in the electronic document being included in the one or more unstable terms of the personal vocabulary profile. The method also includes receiving input that is effective to indicate whether the learner understands the term marked as the unstable term. The method also includes determining whether the learner understands the term marked as the unstable term based on the received input. The method also includes updating the personal vocabulary profile to indicate whether the learner understands the term marked as the unstable term.

### FIELD

The implementations discussed herein are related to a vocabulary learning support system.

### BACKGROUND

Pictures, games and puzzles are popular methods and applications of computer-assisted language learning. With the advent of the Internet, distance learning, on-line instruction, training material publishing, learning resource remote access and cross-reference through hyper linking of Web pages have also been developed for language learning.

The subject matter claimed herein is not limited to implementations that solve any disadvantages or that operate only in environments such as those described above. Rather, this background is only provided to illustrate one example technology area where some implementations described herein may be practiced.

### SUMMARY

According to an aspect of an implementation, a method to build a learner's vocabulary includes accessing a personal vocabulary profile of the learner from a non-transitory computer-readable medium. The personal vocabulary profile includes one or more unstable terms and one or more stable terms. The one or more unstable terms include one or more terms being learned by the learner. The one or more stable terms include one or more terms that have been mastered by the learner. The method also includes marking a term in an electronic document output to a display device as an unstable term in response to the term in the electronic document being included in the one or more unstable terms of the personal vocabulary profile. The method also includes receiving input effective to indicate whether the learner understands the term marked as the unstable term. The method also includes determining whether the learner understands the term marked as the unstable term based on the received input. The method also includes updating the personal vocabulary profile to indicate whether the learner understands the term marked as the unstable term.

The object and advantages of the implementations will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example implementations will be described and explained with additional specificity and detail through the use of the accompanying drawings in which:

FIG. 1 is a block diagram of an example operating environment in which some implementations may be implemented;

FIG. 2 is a block diagram illustrating an example vocabulary building support system to build a learner's vocabulary;

FIG. 3 is a block diagram illustrating an example personal vocabulary profile that may be included in the system of FIG. 2;

FIG. 4 shows an example flow diagram of a method to build a learner's vocabulary;

FIG. 5 shows an example flow diagram of a method to integrate and immerse vocabulary learning into routine reading work

FIG. 6 shows an example flow diagram of a method to estimate a current level of vocabulary knowledge of a learner; and

FIG. 7 shows an example flow diagram of a method to identify and recommend one or more vocabulary terms to learn to a learner.

### DESCRIPTION OF IMPLEMENTATIONS

Some computer-assisted language learning systems may highlight words obtained from specific vocabulary databases (e.g., SAT, TOEFL, GRE, and/or GMAT vocabulary databases) and/or words of a specific difficulty level in an electronic document read by a learner. The learner may be able to mouse over, click on, or otherwise provide some input to request an explanation of the highlighted words. Some of the highlighted words may already be known to the user and/or other words that are not highlighted may be unknown to the user. The highlighting of words that are already known to the user may unnecessarily distract the learner while reading the electronic document. The learner may also be distracted from reading the electronic document if an unknown word is encountered and the learner has to look up a definition or translation of the unknown word; or the learner may be confused if the learner continues reading the electronic document without looking up the definition or translation of the unknown word.

Some other computer-assisted language learning systems may separately provide vocabulary lists (that may include definitions and/or translations) and reading materials that include words from the vocabulary lists. Such systems may test a learner after the learner reads some reading material by, e.g., presenting the learner with the vocabulary list and having the learner translate or define the words in the vocabulary list. Such systems may also track the learner's progress and personalize the learning process by, e.g., recommending vocabulary terms to learn prior to the next lesson and/or increasing or decreasing the amount of reading materials and/or vocabulary in the vocabulary list prior to each lesson, depending on the learner's performance.

In comparison to the foregoing systems, some implementations described herein may integrate and immerse vocabulary learning into routine reading to reinforce the vocabulary learning and routing reading with each other. Alternatively or additionally, new terms found in the routine reading, rather than new terms from a dictionary, may be used for vocabulary building and learning. Alternately or additionally, a personal vocabulary profile of the learner may be dynamically updated during routine reading and/or vocabulary learning efficiency may be improved compared to other systems.

Some implementations described herein may allow a learner to identify terms in the learner's routine reading that are not understood by the learner to be learned in future routine reading. The learner may also be given an explanation of the identified terms, and the identified terms may be automatically highlighted or otherwise marked in future routine reading until the terms have been read and understood by the learner a sufficient number of times to be mastered by the learner.

Implementations of the present invention will be explained with reference to the accompanying drawings.

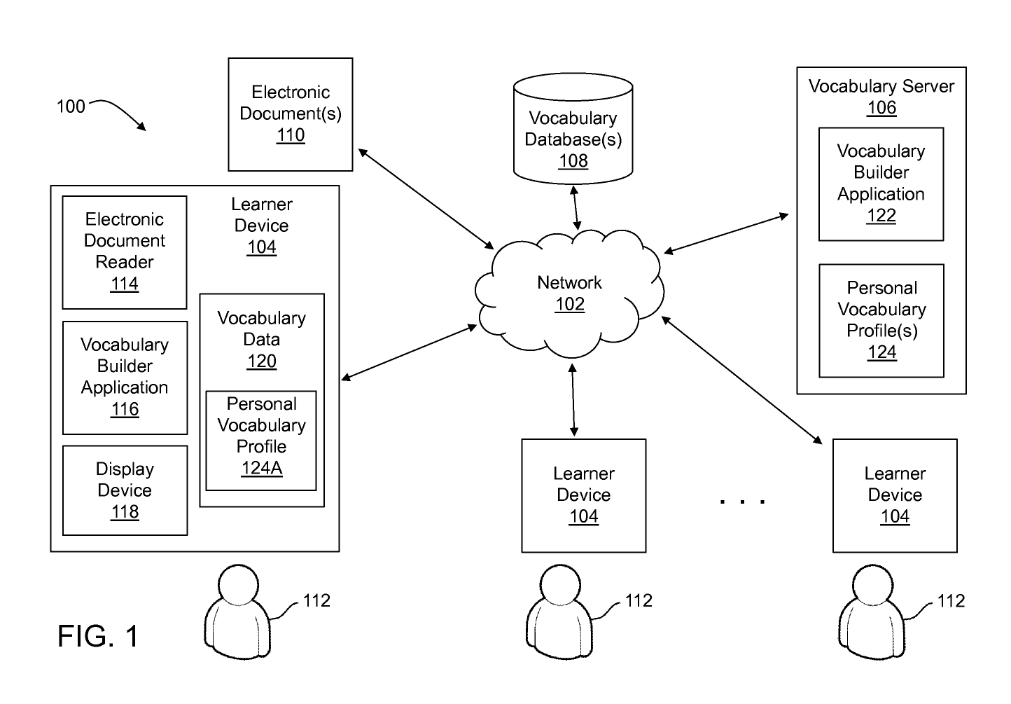

FIG. 1 is a block diagram of an example operating environment 100 in which some embodiments may be implemented. The operating environment may include a network 102, one or more learner devices (hereinafter “learner device” or “learner devices”) 104, a vocabulary server 106, one or more vocabulary databases each of a particular level (hereinafter “vocabulary database” or “vocabulary databases”) 108, one or more electronic documents 110, and one or more learners (hereinafter “learner” or “learners”) 112.

In general, the network 102 may include one or more wide area networks (WANs) and/or local area networks (LANs) that enable the learner devices 104 to access the electronic documents 110 and/or that enable one or more of the learner devices 104, the vocabulary server 106, and/or the vocabulary database 108 to communicate with each other. In some implementations, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

The electronic documents 110 may include web pages, .pdf documents, and/or other files that include at least some textual content. The electronic documents 110 may be hosted at one or more web servers (not shown) accessible to the learner devices 104 via the network 102 or other suitable location. Alternately or additionally, the electronic documents 110 may be accessed locally on the learner devices 104, may be exchanged via device-to-device communication between one of the learner devices 104 and another of the devices or servers of FIG. 1, and/or may be exchanged via thumb drive or other computer storage medium.

Each of the learner devices 104 may include a desktop computer, a laptop computer, a tablet computer, a mobile phone, a smartphone, a personal digital assistant (PDA), an e-reader device, or other suitable learner device. The learner devices 104 may generally be configured to access and display electronic documents 110, including textual content, to the learners 112, and to build a vocabulary of the learners 112. Accordingly, each learner device 112 may include an electronic document reader 114, a vocabulary builder application 116, vocabulary data 120, and a display device 118. For simplicity, the electronic document reader 114, the vocabulary builder application 116, the vocabulary data 120, and the display device 118 are illustrated in FIG. 1 for a single one of the learner devices 104, and each of the other learner devices 104 may similarly include one or more of the foregoing components.

The electronic document reader 114 may be configured to render electronic documents that may include vocabulary terms, other textual content, and/or other content. Rendering an electronic document may include formatting and/or otherwise processing content of the electronic document for output to a display device, to be displayed on the display device. The electronic document reader 114 may include a web browser, an e-reader application, a .pdf reader, a word processor application, or other suitable document viewer and/or document editor.

The vocabulary builder application 116 may generally be configured to improve efficiency and performance of the learner 112 in vocabulary building and learning through the learner 112 reading electronic documents 110. The learners 112 may read the electronic documents 110 for work, school, pleasure, and/or other purposes. The vocabulary builder application 116 may integrate and immerse vocabulary learning into such routine reading to reinforce the vocabulary learning and routine reading with each other. Alternatively or additionally, the vocabulary builder application 116 may use new terms found in the routine reading, rather than new terms from a dictionary, as a starting point for vocabulary building and learning. Alternately or additionally, a personal vocabulary profile of the learner 112 may be dynamically updated during routine reading and/or vocabulary learning efficiency may be improved by the vocabulary builder application 116. In some implementations, the vocabulary builder application 116 may be implemented as a plugin for the electronic document reader 114.

The vocabulary data 120 may include data used by the electronic document reader 114 and/or the vocabulary builder application 116. For instance, the vocabulary data 120 may include one or more electronic documents and/or a personal vocabulary profile 124A of the learner 112 or components thereof that are at least temporarily stored on or otherwise accessible to the learner device 104.

The display device 118 may generally be configured to display the electronic documents 110, including textual content, rendered by the electronic document reader 114. The display device 118 may include a built-in monitor of the learner device 104 implemented as a laptop computer, a tablet computer, a mobile phone, a smartphone, a PDA, an e-reader device, or other learner device with a built-in monitor. Alternately or additionally, the display device 118 may be implemented as an external monitor, a projector, a television, or other suitable display device 118 that may be separate from and communicatively coupled to the learner device 104.

The vocabulary server 106 may host a vocabulary builder application 122 and/or one or more personal vocabulary profiles (hereinafter “personal vocabulary profile” or “personal vocabulary profiles”) 124. The personal vocabulary profiles 124 may include the personal vocabulary profile 124A. The vocabulary builder application 122 may provide a server-based version of the vocabulary builder application 116, e.g., for use in a client-server relationship between the vocabulary server 106 and the learner devices 104. In some implementations, the vocabulary builder application 116 of the learner device 104 may generally include client-side components associated with improving efficiency and performance of the learner 112 in vocabulary building and learning while the vocabulary builder application 122 may generally include server-side components associated with improving efficiency and performance of the learner 112 in vocabulary building and learning.

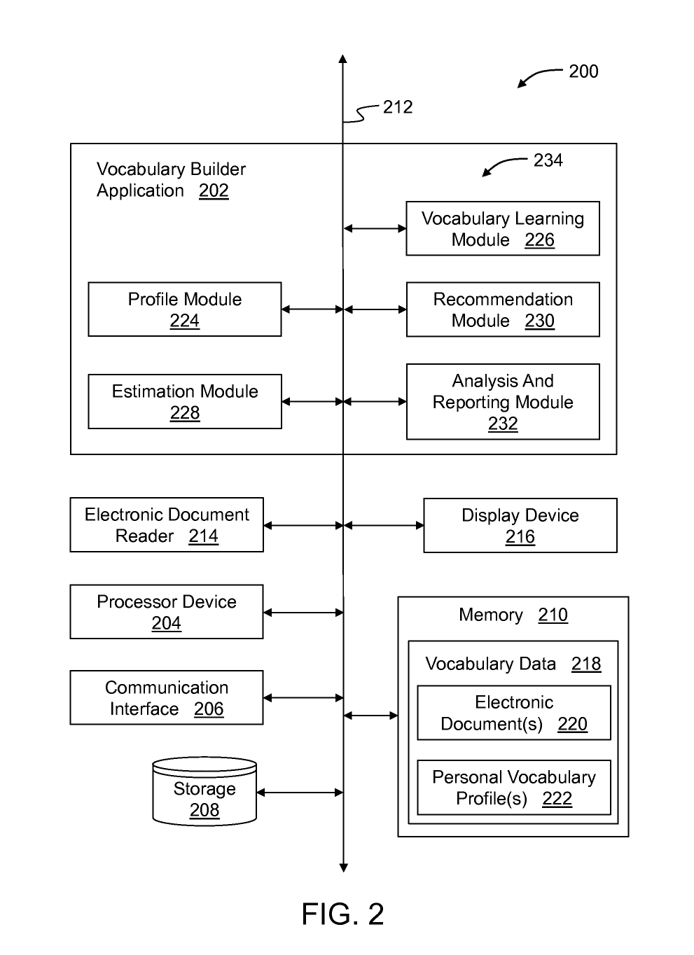

In some implementations, one or both of the vocabulary builder applications 116, 122 may be implemented using hardware including a field-programmable gate array (FPGA) or an application-specific integrated circuit (ASIC). In some other implementations, one or both of the vocabulary builder applications 116, 122 may be implemented using a combination of hardware and software. The vocabulary builder applications 116, 122 may be stored in a combination of the devices and servers, or in one of the devices or servers of FIG. 1. An example implementation of a vocabulary builder application that may correspond to one or both of the vocabulary builder applications 116, 122 is described below in more detail with respect to FIG. 2.

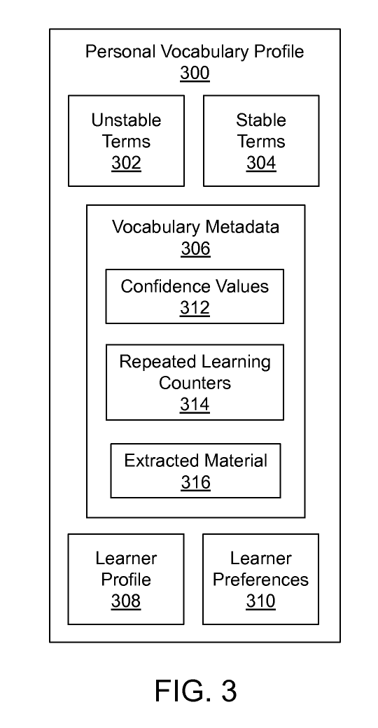

Each of the personal vocabulary profiles 124 may be associated with a different one of the learners 112. An example personal vocabulary profile that may correspond to the personal vocabulary profiles 124 is described in more detail with respect to FIG. 3.

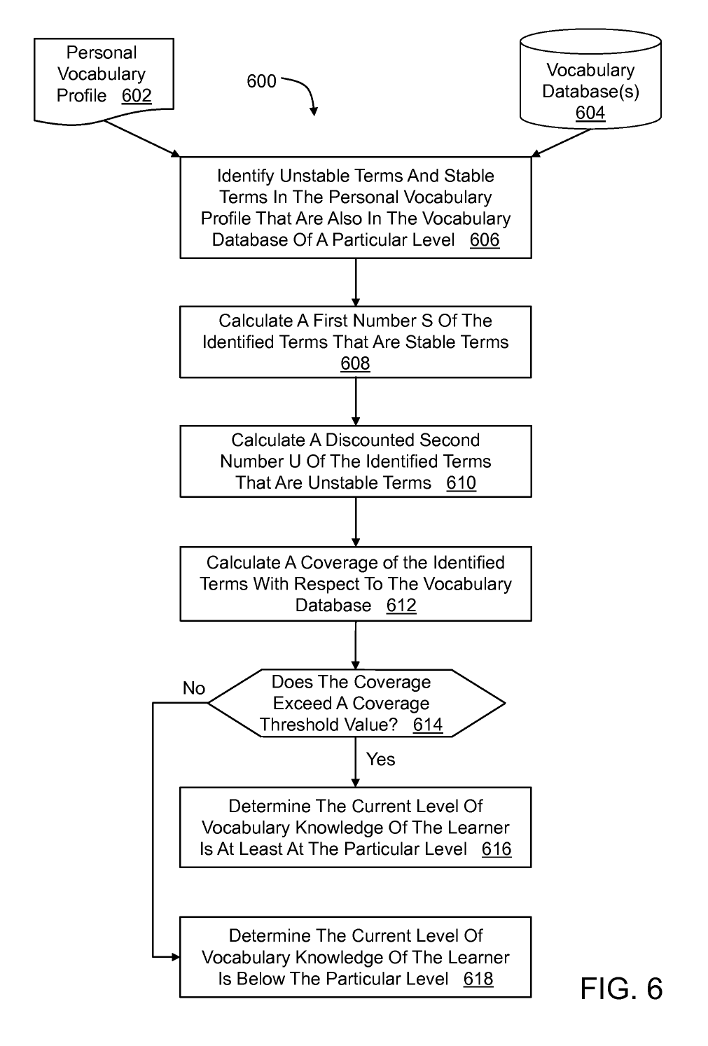

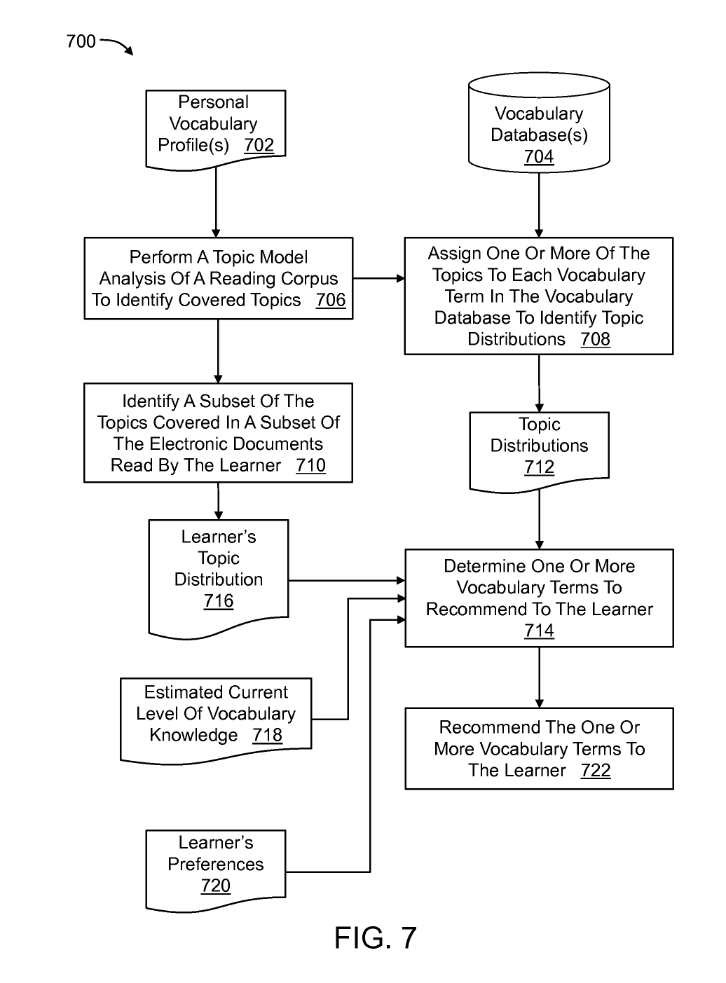

Each of the vocabulary databases 108 may include one or more terms that belong to a particular level of vocabulary knowledge. The vocabulary databases 108 may be obtained from or based on levels of vocabulary knowledge defined by any organization, such as the organizations that administer the Test of English as a Foreign Language (TOEFL™) and/or the International English Language Testing System (IELTS™), or from other suitable sources. As will be described in more detail with respect to, e.g., FIGS. 6 and 7, the vocabulary databases 108 may be used to estimate a current level of vocabulary knowledge of the learners 112 and/or to recommend vocabulary terms for the learners 112 to learn.

FIG. 2 is a block diagram illustrating an example vocabulary building support system (hereinafter “system”) 200 to build a learner's vocabulary, arranged in accordance with at least one implementation described herein. The system 200 may include or correspond to either or both of the learner device 104 and the vocabulary server 106 of FIG. 1. The system 200 may be implemented as a computing device or computing system having any suitable form factor, such as a desktop computer, a laptop computer, a tablet computer, a mobile phone, a smartphone, a personal digital assistant (PDA), an e-reader device, or other suitable computing device.

The system 200 may include a vocabulary builder application 202, a processor device 204, a communication interface 206, a storage 208, and a memory 210 according to some examples. The components of the system 200 may be communicatively coupled by a bus 212. The bus 212 may include, but is not limited to, a memory bus, a storage interface bus, a bus/interface controller, an interface bus, or the like or any combination thereof. In some implementations, the system 200 additionally includes an electronic document reader 214 and a display device 216 both coupled to the bus 212.

The processor device 204 includes an arithmetic logic unit, a microprocessor, a general-purpose controller, or some other processor array to perform or control performance of operations as described herein. The processor device 204 processes data signals and may include various computing architectures including a complex instruction set computer (CISC) architecture, a reduced instruction set computer (RISC) architecture, or an architecture implementing a combination of instruction sets. Although FIG. 2 includes a single processor device 204, multiple processor devices may be included. Other processors, operating systems, and physical configurations may be possible.

The memory 210 stores instructions or data that may be executed or operated on by the processor device 204. The instructions or data may include programming code that may be executed by the processor device 204 to perform or control performance of the operations described herein. In some embodiments, the instructions may include instructions and data which cause the processor device 204 to perform a certain function or group of functions.

In some embodiments the memory 210 may include a computer-readable media for carrying or having computer-executable instructions or data structures stored thereon. Such computer-readable media may be any available media that may be accessed by a processing device 202 that is programmed to execute the computer-executable instructions stored on the computer-readable media. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store desired program code in the form of computer-executable instructions or data structures and which may be accessed by the processor device 204. Combinations of the above may also be included within the scope of computer-readable media.

The memory 210 may store vocabulary data 218. The vocabulary data 218 may include one or more electronic documents (hereinafter “electronic document” or “electronic documents”) 220 and one or more personal vocabulary profiles (hereinafter “personal vocabulary profile” or “personal vocabulary profiles”) 222. The vocabulary data 218 may correspond to the vocabulary data 120 of FIG. 1. Alternately or additionally, the electronic documents 220 may correspond to the electronic documents 110 and/or the personal vocabulary profiles 222 may correspond to the personal vocabulary profiles 124A and/or 124 of FIG. 1.

FIG. 3 is a block diagram illustrating an example personal vocabulary profile 300, arranged in accordance with at least one implementation described herein. The personal vocabulary profile 300 is an example of the personal vocabulary profiles 124 and 222 of FIGS. 1 and 2 and may be associated with a particular learner. As illustrated in FIG. 3, the personal vocabulary profile 300 may include one or more unstable terms (hereinafter “unstable term” or “unstable terms”) 302 and one or more stable terms (hereinafter “stable term” or stable terms”) 304. Alternately or additionally, the personal vocabulary profile 300 may include vocabulary metadata 306, a learner profile 308, and/or learner preferences 310.

The unstable terms 302 may include terms that are being learned by a learner, while the stable terms 304 may include terms that have been mastered by the learner. In some implementations, a term is considered as having been mastered, and thus a stable term, if it has been read and understood by a learner at least a minimum number of times, while a term is considered as being learned, and thus an unstable term, if it has not been read and understood by the learner at least the minimum number of times. An unstable term may become a stable term after the unstable term has been read and understood by the learner at least the minimum number of times. Alternately or additionally, a stable term may become an unstable term if it is forgotten by the learner and the learner provides some indication that the stable term is no longer understood by the learner.

The vocabulary metadata 306 may include one or more of confidence values 312, repeated learning counters 314, and extracted material 316.

The confidence values 312 may include a different confidence value for each of the unstable terms 302. The confidence values for the unstable terms 302 may each generally be represented by a variable C in the discussion herein. Each of the confidence values 312 may indicate a number of times a corresponding one of the unstable terms 302 is read and correctly understood by a learner, or a number of times in a row that the corresponding one of the unstable terms 302 is read and correctly understood by the learner.

The repeated learning counters 314 may include a different repeated learning counter for each of the unstable terms 302. The repeated learning counters for the unstable terms 302 may each generally be represented by a variable R in the discussion herein. Each of the repeated learning counters 314 may indicate a number of times a corresponding one of the unstable terms 302 is read by the learner.

The extracted material 316 may include a context sentence for each of at least one of the unstable terms 302. The context sentences may be extracted from electronic documents read by the learner. For example, the extracted material 316 may include context sentences for the unstable terms 302, where the context sentences are extracted from electronic documents read by the learner. The context sentences in the extracted material 316 may be provided to the learner as an explanation of a corresponding unstable term included therein in response to the learner requesting such an explanation.

The learner profile 308 may include data that, at least in aggregate, uniquely identifies the learner. For example, the learner profile 308 may include one or more of a unique user id, a name, a username, an address, an e-mail address, a mobile phone number, a date of birth, or other information of the learner.

The learner preferences 310 may include one or more preferences of the learner with respect to building the learner's vocabulary. For example, the learner preferences 310 may indicate one or more topics of interest to the user, whether the user wants to receive recommendations for vocabulary terms to learn, whether the user is interested in recommendations for vocabulary terms that are related to the indicated topics of interest, recommendations for vocabulary terms that are not related to the indicated topics of interest, recommendations for vocabulary terms that are related to topics covered by electronic documents read by the learner (hereinafter “learner's topic distribution”), recommendations for vocabulary terms that are not related to the learner's topic distribution, and/or other learner preferences.

Returning to FIG. 2, the communication interface 206 transmits and receives data to and from at least one of the learner device 104, the vocabulary server 106, the vocabulary database 108, and any other entities of the operating environment 100 of FIG. 1. In some implementations, the communication interface 206 includes a port for direct physical connection to the network 102 of FIG. 1 or to another communication channel. For example, the communication interface 206 may include a universal serial bus (USB) port, a secure digital (SD) port, a category 5 cable (CAT-5) port, or similar port for wired communication with the learner device 104, the vocabulary server 106, the vocabulary database 108, or any other entities of FIG. 1. In some implementations, the communication interface 206 includes a wireless transceiver for exchanging data with at least one of the learner device 104, the vocabulary server 106, the vocabulary database 108, or any other entities of FIG. 1 or other communication channels using one or more wireless communication methods, including IEEE 802.11, IEEE 802.16, BLUETOOTH®, or another suitable wireless communication method.

In some implementations, the communication interface 206 includes a cellular communications transceiver for sending and receiving data over a cellular communications network including via short messaging service (SMS), multimedia messaging service (MMS), hypertext transfer protocol (HTTP), direct data connection, wireless application protocol (WAP), e-mail, or another suitable type of electronic communication. In some implementations, the communication interface 206 includes a wired port and a wireless transceiver. The communication interface 206 may also provide other connections to the network 102 of FIG. 1 for distribution of files or media objects using standard network protocols including transmission control protocol/internet protocol (TCP/IP), HTTP, HTTP secure (HTTPS), and simple mail transfer protocol (SMTP), etc.

The storage 208 may include a non-transitory storage medium that stores data for providing the functionality described herein. The storage 208 may include a dynamic random access memory (DRAM) device, a static random access memory (SRAM) device, flash memory, or some other memory devices. In some implementations, the storage 208 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 208 may also store instructions and/or data that are temporarily stored or loaded into the memory 210.

As illustrated in FIG. 2, the vocabulary builder application 202 may include at least one of: a profile module 224, a vocabulary learning module 226, an estimation module 228, a recommendation module 230, and an analysis and reporting module 232, collectively referred to herein as “modules 234”. The vocabulary builder application 202, including the modules 234, and the electronic document reader 214 may generally include software that includes programming code and/or computer-readable instructions executable by the processor device 204 to perform or control performance of the functions and operations described herein. The vocabulary builder application 202, including one or more of the modules 234, and the electronic document reader 214 may receive data from another one of the components of the system 200 and may store the data in one or both of the storage 208 and the memory 210.

In some implementations, one or more of the modules 234 may be stored, at least temporarily, in one or both of the storage 208 and the memory 210. Alternately or additionally, one or more of the modules 234 may be implemented at least partially in hardware. As used herein, the terms “module” or “component” may refer to specific hardware implementations configured to perform the operations of the module or component and/or software objects or software routines that may be stored on and/or executed by the system 200. In some implementations, the different components and modules described herein may be implemented as objects or processes that execute on a computing system (e.g., as separate threads). While some of the system and methods described herein are generally described as being implemented in software (stored on and/or executed by the system 200), specific hardware implementations or a combination of software and specific hardware implementations are also possible and contemplated. In this description, a “computing entity” may include any computing system as previously defined herein, or any module or combination of modules running on a computing system such as the system 200.

The profile module 224 may generally be configured to create and update the personal vocabulary profile 222 of each of one or more learners, such as the learners 112 of FIG. 1, as described in more detail herein. The vocabulary learning module 226 may generally be configured to build a learner's vocabulary, as described in more detail herein. The estimation module 228 may generally be configured to estimate a current level of vocabulary knowledge of the learner, as described in more detail herein. The recommendation module 230 may generally be configured to recommend to the learner one or more vocabulary terms to learn, as described in more detail herein. The analysis and reporting module 232 may generally be configured to analyze vocabulary learning of the learner and report at last some results of the analysis to the learner.

The electronic document reader 214 may generally correspond to or include the electronic document reader 114 of FIG. 1. In some implementations, the electronic document reader 214 is configured to render electronic documents 220, including textual content, and possibly other content, of the electronic documents 220. Rendering the electronic documents 220 may include formatting and/or otherwise processing the electronic documents 220 for output to a display device, such as the display device 216.

The display device 216 may be communicatively coupled to the electronic document reader 214, e.g., via the bus 212. Rendered electronic documents output by the electronic document reader 214 may be displayed to a learner on the display device 216.

An example implementation involving a learner that has the personal vocabulary profile 300 of FIG. 3 as one of the personal vocabulary profiles 222 stored in the memory 210 of FIG. 2 will now be discussed with combined reference to FIGS. 2 and 3.

The electronic document reader 214 may render one of the electronic documents 220. The display device 216 may display the rendered electronic document to the learner. The profile module 224 may access the personal vocabulary profile 300 of the learner from the personal vocabulary profiles 222. The vocabulary learning module 226 may mark a term in the electronic document output to the display device 216 as an unstable term in response to the term in the electronic document being included in the unstable terms 302 of the personal vocabulary profile 300. For example, the vocabulary learning module 226 may mark the term as an unstable term by causing the term to be highlighted or otherwise indicated as being an unstable term in the electronic document displayed on the display device 216.

The vocabulary learning module 226 may also receive input from the learner and determine whether the learner understands the term marked as the unstable term based on the received input. The input may be received through a user interface of the system 200, which user interface may include a mouse, keyboard, touchpad, touchscreen, or other input device. In some implementations, the vocabulary learning module 226 may determine that the learner understands the term marked as the unstable term in response to the learner providing input effective to indicate that the learner understands the term. Alternately or additionally, the vocabulary learning module 226 may determine that the learner does not understand the term marked as the unstable term in response to the learner providing input effective to request an explanation of the term marked as the unstable term or to otherwise indicate that the learner does not understand the term marked as the unstable term. Alternately or additionally, the vocabulary learning module 226 may apply a default rule in which the term marked as the unstable term is determined as being understood by the learner in response to the learner not providing any input with respect to the term marked as the unstable term, e.g., it may be assumed that the learner understands the term marked as the unstable term unless the learner requests an explanation or otherwise indicates that it is not understood.

The profile module 224 may update the personal vocabulary profile 300 to indicate whether the learner understands the term marked as the unstable term. The profile module 224 may update the personal vocabulary profile by zeroing out or decrementation of a counter included in the personal vocabulary profile 300 and associated with the unstable term in response to a determination by the vocabulary learning module 226 that the learner does not understand the term marked as the unstable term. The counter may include a confidence value C of the unstable term included in the confidence values 312. Alternately or additionally, the profile module 224 may update the personal vocabulary profile by incrementation of the counter in response to a determination by the vocabulary learning module 226 that the learner understands the term marked as the unstable term. In some implementations, the profile module 224 may be further configured to, in response to incrementation of the counter to a counter threshold value M_C, change the unstable term to a stable term. For example, the personal vocabulary profile 300 may be updated such that the term is included in the stable terms 304 rather than the unstable terms 302.

The term marked as the unstable term may be referred to as a first term. In some implementations, the vocabulary learning module 226 may receive input effective to identify a second term in the electronic document as not understood by the learner. The second term may include a term that is not included in the unstable terms 302, or may include a term that is included in the stable terms 304 and has been forgotten by the learner. The vocabulary learning module 226 may also provide an explanation of the second term to the learner. The vocabulary learning module 226 may provide the explanation of the second term to the learner by provision to the learner of at least one of: a definition of the second term, a translation of the second term (e.g., a translation from a language in which the second term appears to a different language that may be a first language of the learner), or a sentence that includes the second term in context (hereinafter “context sentence”). The definition, translation, or context sentence may be obtained from any source, including a local or online repository, dictionary, translation dictionary, or the like.

Alternately or additionally, the profile module 224 may add the second term to the unstable terms 302 of the personal vocabulary profile 300. The vocabulary learning module 226 may extract, from the electronic document, a first context sentence that includes the first term and a second context sentence that includes the second term. The profile module 224 may add the first context sentence and the second context sentence to the personal vocabulary profile 300, and more particularly, to the extracted material 316. Subsequently, the electronic document reader 214 may render a second electronic document that is displayed on the display device 216. The second electronic document may include at least one of the first term or the second term. In response to receipt of input effective to request an explanation of the first term or the second term, the vocabulary learning module 226 may provide an explanation that includes the first context sentence or the second context sentence as an example sentence of the first term or the second term in context.

In some implementations, the vocabulary learning module 226 may mark multiple terms in the electronic document as unstable terms in response to the multiple terms in the electronic document being included in the unstable terms 302 of the personal vocabulary profile 300. The vocabulary learning module 226 may generate an index that includes each of the multiple terms that are marked as unstable terms in the electronic document. In response to receipt of input effective to select one of the multiple terms in the index, the vocabulary learning module 226 may navigate to a sentence of the electronic document that includes the selected one of the multiple terms and/or may provide to the learner an explanation of the selected one of the multiple terms. The explanation may include: a definition of the selected one of the multiple terms, a translation of the selected one of the multiple terms, or a sentence that includes the selected one of the multiple terms in context.

The estimation module 228 may estimate the current level of vocabulary knowledge of the learner, which may include one or more of the following. The estimation module 228 may identify multiple terms in the unstable terms 302 and the stable terms 304 that are also in a vocabulary database of a particular level of vocabulary knowledge, such as the vocabulary database 108. The vocabulary database may include a total number of terms N. The estimation module 228 may calculate a first number S of the identified multiple terms that are included in the stable terms 304.

The estimation module 228 may calculate a discounted second number U of the identified multiple terms that are included in the unstable terms 302. The discounted second number U may be calculated in some implementations as the sum of the confidence values C of the identified multiple terms that are included in the unstable terms 302 divided by the counter threshold value M_C. For example, if five of the identified multiple terms are included in the unstable terms 304 and have respective confidence values C within the confidence values 312 of the personal vocabulary profile 300 of 2, 6, 7, 1, and 5, and if the counter threshold value M_C is 8, then the discounted second number U may be calculated as: (2+6+7+1+5)/8=2.625 in some implementations.

The estimation module 228 may calculate a coverage of the identified multiple terms with respect to the vocabulary database based on the total number of terms N in the vocabulary database, the first number S, and the discounted second number U. For example, the coverage may be calculated as (S+U)/N. When the calculated coverage is above a coverage threshold value, the estimation module 228 may determine that the current level of vocabulary knowledge of the learner is at least the particular level of the vocabulary database. When the calculated coverage is below the coverage threshold value, the estimation module 228 may determine that the current level of vocabulary knowledge of the learner is below the particular level. Alternately or additionally, the estimation module 228 may repeat the foregoing with respect to one or more other vocabulary databases of different particular levels until a current level of vocabulary knowledge of the learner is determined.

The recommendation module 230 may recommend to the learner one or more vocabulary terms to learn, which may include one or more of the following. The recommended vocabulary terms to learn may be determined based on the estimated current level of vocabulary knowledge of the learner. The recommendation module 230 may perform a topic model analysis of a reading corpus that includes electronic documents read by multiple learners (including the learner) to identify multiple topics covered in the reading corpus. The reading corpus may include all or some of the electronic documents read by the learners ever or for a particular duration of time. Accordingly, the personal vocabulary profile of each of the learners may be updated to include a listing of or otherwise indicate the electronic documents that have been read by the learner. In some implementations, a “topic” determined or output by the topic model analysis may include a probability distribution of terms.

The recommendation module 230 may assign one or more of the topics to each of multiple vocabulary terms in a vocabulary database to generate multiple topic distributions. Each of the vocabulary terms may include a corresponding topic distribution. The recommendation module 230 may identify a subset of the topics covered in the electronic documents read by the learner, which may be referred to as the learner's topic distribution. For instance, the recommendation module 230 may identify the learner's topic distribution by determining, based on the topics output by the topic model analysis, which of the topics are discussed in the electronic documents read by the learner.

The recommendation module 230 may determine the recommended vocabulary terms to learn based on the estimated current level of vocabulary knowledge of the learner, the learner's topic distribution, and the topic distributions. For example, the recommendation module 230 may determine the recommended vocabulary terms as vocabulary terms that are at the same or a little higher vocabulary level as the current level of vocabulary knowledge of the learner, that are generally included in the learner's topic distribution, and/or that include topic distributions that are similar in at least some respects to topic distributions of vocabulary terms included in the unstable and/or stable terms 304 of the learner.

Alternately or additionally, the recommendation module 230 may determine the recommended vocabulary terms to learn based on the learner preferences 310. For example, the recommended vocabulary terms may include vocabulary terms from the vocabulary database with topic distributions that indicate the vocabulary terms match topics of interest specified in the learner preferences 310. In some implementations, each of the vocabulary terms recommended as a vocabulary term to learn may be categorized in the estimated current level of vocabulary knowledge of the learner and/or a topic distribution of each of the vocabulary terms recommended as a vocabulary term to learn may have at least one topic in common with the learner's topic distribution.

The analysis and reporting module 232 may analyze vocabulary learning of the learner and report at last some results of the analysis to the learner. For example, the analysis and reporting module 232 may generate a report each time the learner reads an electronic document and/or at any other time and may output the report to the learner. The analysis may determine one or more of a ranking, by repeated learning time for the learner, of terms; a ranking, by repeated learning time for the learner, of terms in the personal vocabulary profile of the learner; a ranking, by repeated learning time across multiple learners, of terms in personal vocabulary profiles of the learners; and a ranking, by vocabulary coverage rate, of the learner with respect to others of the learners. The repeated learning time of the learner for a given term may include the value of the repeated learning counter R corresponding to the given term and that is included in the repeated learning counters 314. One or more of the foregoing rankings may be included in the report generated by the analysis and reporting module 232 and output to the learner.

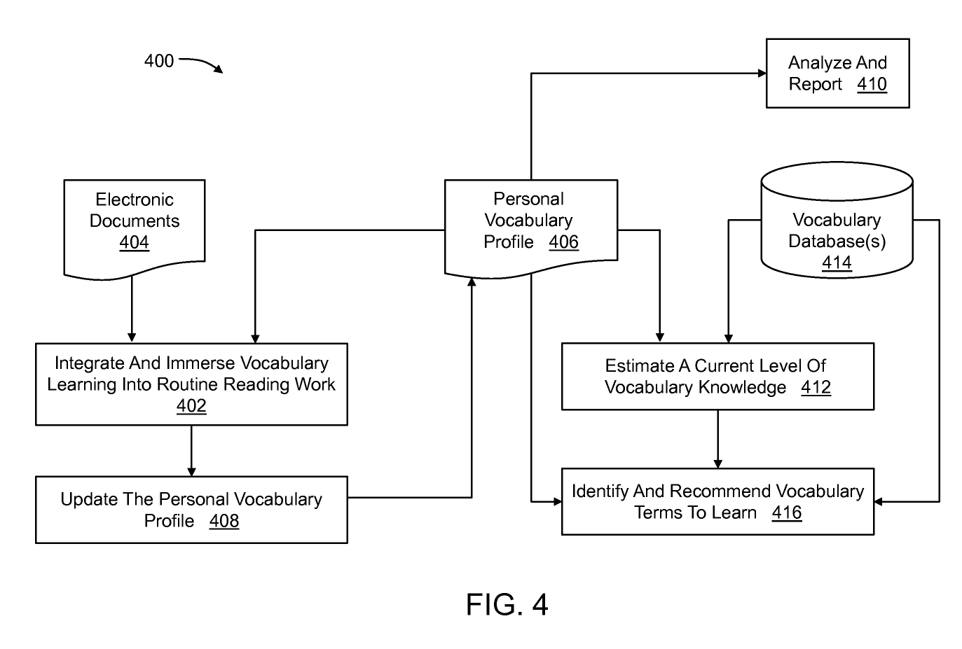

FIG. 4 shows an example flow diagram of a method 400 to build a learner's vocabulary, arranged in accordance with at least one implementation described herein. The method 400 may be implemented, in whole or in part, by one or more of the learner devices 104 or vocabulary server 106 of FIG. 1, the system 200 of FIG. 2, or another suitable device, server, and/or system. The method 400 may begin at block 402.

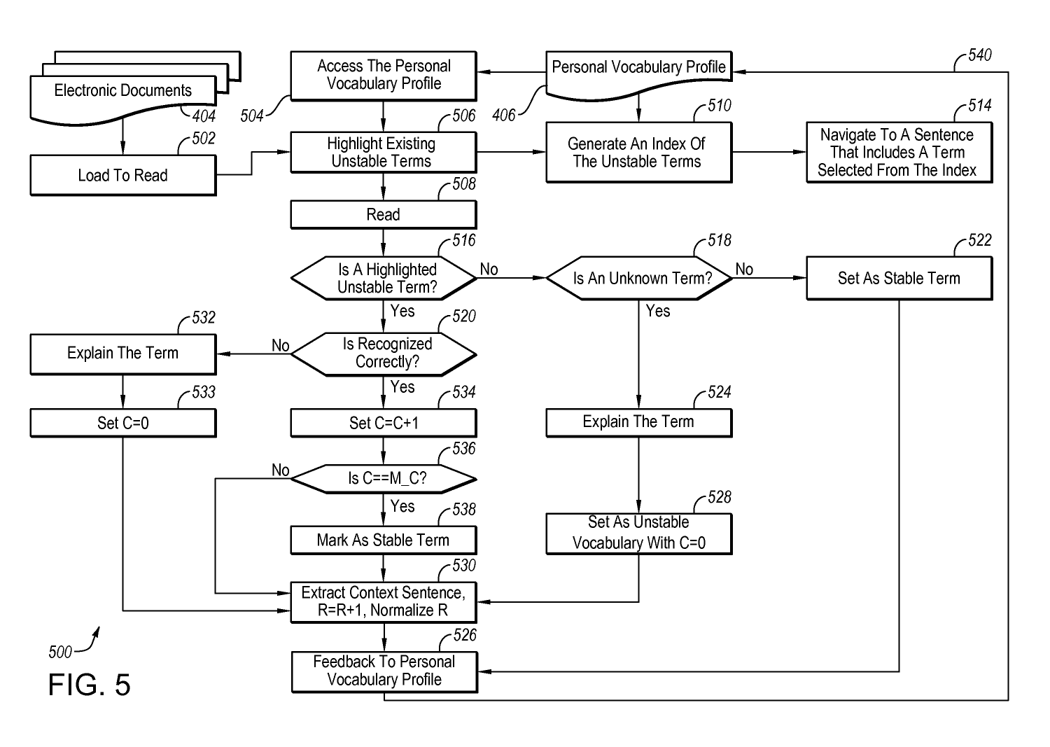

In block 402, vocabulary learning of a learner may be integrated and immersed into routine reading work. The integration and immersion of vocabulary learning may be implemented using one or more electronic documents 404 that are the subject of the routine reading working and using a personal vocabulary profile 406 of the learner. The electronic documents 404 may correspond to the electronic documents 110 of FIG. 1, the electronic documents 220 of FIG. 2, or other electronic documents described herein. The personal vocabulary profile 406 may be included in or correspond to the personal vocabulary profiles 124 of FIG. 1, the personal vocabulary profiles 222 of FIG. 2, the personal vocabulary profile 300 of FIG. 3, or other personal vocabulary profiles described herein. An example method to integrate and immerse vocabulary learning into routine reading work is described with respect to FIG. 5. Block 402 may be followed by block 408.

In block 408, the personal vocabulary profile 406 may be updated. The personal vocabulary profile 406 may be updated during and/or after the integration and immersion of vocabulary learning into routine reading working. Updating the personal vocabulary profile 406 may include one or more of: adding an extracted context sentence to extracted material of the personal vocabulary profile, adding a term to the personal vocabulary profile as an unstable term, initializing a confidence value C of the newly added unstable term at zero, initializing a repeated learning counter R of the newly added unstable term at zero, incrementing a confidence value C and/or a repeated learning counter R of an unstable term in the personal vocabulary profile 406, zeroing out or decrementing the confidence value C of the unstable term, changing the unstable term to a stable term in the personal vocabulary profile 406, and changing a stable term to an unstable term in the personal vocabulary profile 406. In these and other implementations, the update may be accomplished by sending a write command to a memory or storage on which the personal vocabulary profile 406 is stored. Example methods to update a personal vocabulary profile are described with respect to FIG. 5.

In block 410, the vocabulary learning of the learner may be analyzed and at least some results of the analysis may be reported, e.g., to the learner. Analyzing the vocabulary learning of the learner and reporting at least some results of the analysis to the learner may include generating a report that is output to the learner, e.g., via a display device on which electronic documents are displayed to the learner. The report may include one or more of the rankings determined by the analysis described previously, or other information.

In block 412, a current level of vocabulary knowledge of the learner may be estimated. The current level of vocabulary knowledge may be estimated based on the personal vocabulary profile 406 and one or more vocabulary databases each of a particular level (hereinafter “vocabulary database” or “vocabulary databases”) 414. The vocabulary database 414 may correspond to or include the vocabulary database 108 of FIG. 1. An example method to estimate a current level of vocabulary knowledge of the learner is described with respect to FIG. 6. Block 412 may be followed by block 416.

In block 416, vocabulary terms to learn may be identified and recommended to the learner. The vocabulary terms to learn may be determined based on the personal vocabulary profile 406, the vocabulary database 414, and the estimated current level of vocabulary knowledge. An example method to identify and recommend one or more vocabulary terms to learn to a learner is described with respect to FIG. 7.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

FIG. 5 shows an example flow diagram of a method 500 to integrate and immerse vocabulary learning into routine reading work, arranged in accordance with at least one implementation described herein. The method 500 may be implemented, in whole or in part, by one or more of the learner devices 104 or vocabulary server 106 of FIG. 1, the system 200 of FIG. 2, or another suitable device, server, and/or system. The method 500 may include portions of and/or overlap with the method 400 of FIG. 4.

In block 502 (“Load To Read”), an electronic document, such as one of the electronic documents 404, may be rendered. For example, the electronic document may be rendered by the electronic document reader 214 of FIG. 2. Alternately or additionally, the method 500 may include displaying the rendered document on a display device, such as the display device 216 of FIG. 2. Block 502 may be followed by block 506, which will be described further below.

In block 504 (“Access The Personal Vocabulary Profile”), the personal vocabulary profile 406 of the learner may be accessed. For example, the personal vocabulary profile 406 may be accessed by the profile module 224 of FIG. 2. Block 504 may be followed by block 506.

In block 506 (“Highlight Existing Unstable Terms”), terms in the electronic document may be marked as unstable terms in response to the terms being included in the unstable terms of the personal vocabulary profile 406. The terms may be marked by the vocabulary learning module 226 of FIG. 2. For example, the vocabulary learning module 226 may mark the terms as unstable terms by causing the terms to be highlighted or otherwise indicated as being unstable terms in the electronic document displayed on the display device 216. Block 506 may be followed by one or both of blocks 508 and 510.

In block 510 (“Generate An Index Of The Unstable Terms”), an index of unstable terms included in the electronic document displayed on the display device may be generated. The index may be generated by the vocabulary learning module 226 of FIG. 2. The index may be displayed on the display device. For example, the index of unstable terms may be displayed in a window such as a floating window within the displayed electronic document or in a separate window separate from the displayed electronic document, as a drop-down index, or in some other form on the display device. Input effective to select one of the unstable terms in the index may be received. The input may be received by the vocabulary learning module 226 of FIG. 2. The learner may provide the input using any suitable input device. Block 510 may be followed by block 514.

In block 514 (“Navigate To A Sentence That Includes A Term Selected From The Index”), the electronic document displayed on the display device may be navigated to a sentence that includes the selected term and/or an explanation of the selected term may be provided. The vocabulary learning module 226 of FIG. 2 may navigate to the sentence and/or provide the explanation. Navigating to the sentence that includes the selected term may include causing a portion of the electronic document that includes the sentence to be displayed on the display device. Alternately or additionally, navigating to the sentence that includes the selected term may include highlighting or otherwise marking the sentence. Navigating to the sentence may allow the learner to see the selected term in the context of the sentence within the electronic document. Providing an explanation of the selected term may include providing to the learner one or more of: a definition of the selected term, a translation of the selected term, and a context sentence that includes the selected term in context in a different electronic document. The explanation described here and elsewhere may be provided to the learner by causing the explanation to be displayed on the display device or otherwise output to the learner.

In block 508 (“Read”), the learner may read the electronic document displayed on the display device. Block 508 may be followed by block 516.

In block 516 (“Is A Highlighted Unstable Term?”), the learner may determine whether a term read by the learner is marked as an unstable term. For instance, if the term is highlighted or otherwise marked as an unstable term, the learner may determine that the term is marked as an unstable term. Block 516 may be followed by block 518 (“No” at block 516) or by block 520 (“Yes” at block 516).

In block 518 (“Is An Unknown Term?”), it is determined whether the term in the electronic document that is not marked as an unstable term is unknown to the user. The vocabulary learning module 226 of FIG. 2 may make the determination at block 518 based on input from the learner and/or based on an absence of input. For instance, the learner in some implementations may provide input effective to indicate when the term that is not marked as an unstable term is unknown to the learner and may not provide any input when the term that is not marked as an unstable term is known to the learner. In these and other implementations, the learner may use an input device to mark, select, or otherwise identify the term that is not marked as an unstable term when it is not understood by the learner.

In some implementations, a user may forget terms that have been mastered already (e.g., stable terms in the personal vocabulary profile 406), and the user may provide input effective to indicate that the term is unknown to the learner such that it may be determined that the term is an unknown term. Thus, unknown terms may include terms the learner has not learned previously, as well as terms the learner has previously mastered and subsequently forgot. Block 518 may be followed by block 522 (“No” at block 518) or by block 524 (“Yes” at block 518).

In block 522 (“Set As Stable Term”), a term in the document that is not marked as an unstable term and that is determined to be known to the learner may be set as a stable term in the personal vocabulary profile 406 of the learner or may be confirmed as already included in the stable terms of the personal vocabulary profile 406 of the learner. The profile module 224 of FIG. 2 may set the term as the stable term in the personal vocabulary profile or may confirm it is already included in the stable terms in the personal vocabulary profile. Setting the term as the stable term is an example of updating the personal vocabulary profile 406 as described with respect to FIG. 4. Block 522 may be followed by block 526, to be described below.

In block 524 (“Explain The Term”), an explanation of a term in the document that is not marked as an unstable term and that is determined to be unknown to the learner may be provided to the learner. The explanation may be provided by the vocabulary learning module 226 of FIG. 2. Providing an explanation of the term may include providing to the learner one or more of: a definition of the term, a translation of the term, and a sentence that includes the term in context, where the sentence may be different than a sentence in the electronic document that includes the term. Block 524 may be followed by block 528.

In block 528 (“Set As Unstable Term With C=0”), the term in the document that is not marked as an unstable term and that is determined to be unknown to the learner may be added to the personal vocabulary profile 406 as an unstable term and a confidence value C of the term added to the personal vocabulary profile 406 as the unstable term may be initialized at zero. Alternately or additionally, a repeated learning counter R of the term added to the personal vocabulary profile 406 as the unstable term may be initialized at zero. The profile module 224 of FIG. 2 may add the term as an unstable term to the personal vocabulary profile 406 and may initialize the confidence value C and repeated learning counter R of the term at zero. Block 528 may be followed by block 530, to be described below.

In block 520 (“Is Recognized Correctly?”), and in response to a term in the electronic document being marked as an unstable term, it is determined whether the learner understands the term marked as the unstable term. The determination at block 520 may be made by the vocabulary learning module 226 of FIG. 2. In these and other implementations, when the term is marked in the electronic document as an unstable term, the learner may provide, via an input device, input effective to indicate whether the learner understands the term marked as the unstable term. The determination of whether the learner understands the term marked as the unstable term may thus be based on the received input. If it is determined that the term marked as the unstable term is not understood (“No” at block 520), the method 500 may proceed to block 532. If it is determined that the term marked as the unstable term is understood (“Yes” at block 520), the method 500 may proceed to block 534.

In block 532 (“Explain The Term”), and response to the determination that the learner does not understand the term marked as the unstable term, an explanation of the unstable term determined not to be understood by the learner may be provided to the learner. The explanation may be provided by the vocabulary learning module 226 of FIG. 2. Providing an explanation of the unstable term may include providing to the learner one or more of: a definition of the unstable term, a translation of the unstable term, and a sentence that includes the unstable term in context, where the sentence may be different than a sentence in the electronic document that includes the unstable term. Each of the foregoing may be considered a type of explanation. In some implementations, a single one of the foregoing different types of explanations may be provided to the learner. Alternately or additionally, the learner may provide input effective to indicate which type of multiple available different types of explanations the learner would like to receive. Block 532 may be followed by block 533.

In block 533 (“Set C=0”), a confidence value C of the unstable term in the personal vocabulary profile 406 may be zeroed out. Alternately, the confidence value C may be decremented, e.g., by one or some other value. The profile module 224 of FIG. 2 may zero out (or decrement) the confidence value C. Zeroing out (or decrementing) the confidence value C of the term marked as the unstable term is an example of updating the personal vocabulary profile 406 as described with respect to FIG. 4. Block 533 may be followed by block 530, described in more detail below.

In block 534 (“Set C=C+1”), and responsive to the determination that the learner understands the term marked as the unstable term, the confidence value C of the unstable term in the personal vocabulary profile 406 may be incremented, e.g., by one or some other value. The profile module 224 of FIG. 2 may increment the confidence value C. In some implementations, the confidence value C for a given unstable term is incremented once per electronic document read by the learner if it is determined that the learner understands the term, even if the unstable term occurs multiple times in the same electronic document. In other implementations, the confidence value C for a given unstable term is incremented each time the unstable term is determined to be understood by the learner, including incrementing the confidence value C multiple times if the unstable term occurs multiple times in a given electronic document and is determined to be understood by the learner each time it is read by the learner. Incrementing the confidence value C of the term marked as the unstable term is an example of updating the personal vocabulary profile 406 as described with respect to FIG. 4. Block 534 may be followed by block 536.

In block 536 (“Is C==M_C?”), it may be determined whether the confidence value C of the unstable term in the personal vocabulary profile 406 is equal to the counter threshold value M_C. The determination may be made by the profile module 224 of FIG. 2. If it is determined that the confidence value C is not equal to the counter threshold value M_C (“No” at block 536), block 536 may be followed by block 530. If it is determined that the confidence value C is equal to the counter threshold value M_C (“Yes” at block 536), block 536 may be followed by block 538.

The counter threshold value M_C may be set sufficiently high such that the learner's correct understanding of the unstable term M_C times in a row may indicate that the unstable term has been mastered, and is thus no longer an unstable term for the learner. Accordingly, in block 538 (“Mark As Stable Term”) and responsive to the confidence value C of the unstable term being determined to be equal to the counter threshold value M_C, the unstable term may be changed to a stable term in the personal vocabulary profile 406. The profile module 224 of FIG. 2 may change the unstable term to the stable term in the personal vocabulary profile 406 responsive to the confidence value C being determined to be equal to the counter threshold value M_C. In these and other implementations, the counter threshold value M_C may be set by the learner and/or may be stored in learner preferences of the personal vocabulary profile 406. Alternately or additionally, a default value of the counter threshold value M_C may be determined by machine learning and/or may be automatically adjusted using machine learning over time for a given learner depending on how quickly the learner masters terms and/or whether the learner forgets terms that have been mastered. Changing the unstable term to a stable term in the personal vocabulary profile 406 is an example of updating the personal vocabulary profile 406 as described with respect to FIG. 4. Block 538 may be followed by block 530.

In block 530 (“Extract Context Sentence, R=R+1, Normalize R”), a context sentence that includes the corresponding term from block 533, 536, 538, or 528 may be extracted from the electronic document. The context sentence may be extracted by the vocabulary learning module 226 of FIG. 2. The context sentence may be saved to the personal vocabulary profile 406, e.g., by the profile module 224 of FIG. 2, and may be subsequently provided to the learner as an explanation of the corresponding term if such an explanation is requested by the learner when the learner is reading a different electronic document that includes the term. Extracting the context sentence from the electronic document and/or saving the extracted context sentence to the personal vocabulary profile 406 is/are an example of updating the personal vocabulary profile 406 as described with respect to FIG. 4.

Alternately or additionally, in block 530, a repeated learning counter R of the corresponding term in the personal vocabulary profile 406 may be incremented, e.g., by one or some other value. The profile module 224 of FIG. 2 may increment the repeated learning counter R. The repeated learning counter R for the corresponding term may be incremented once per electronic document in which the corresponding term occurs at least once, or may be incremented once per occurrence including multiple times for multiple occurrences in the same electronic document. Incrementing the repeated learning counter R for the corresponding term in the personal vocabulary profile 406 is an example of updating the personal vocabulary profile 406 as described with respect to FIG. 4.

Alternately or additionally, in block 530, the repeated learning counter R of the corresponding term may be normalized by its frequency distribution in a reading corpus that may include all or at least some of the electronic documents read by one or more learners. Normalizing the repeated learning counter R for the corresponding term in the personal vocabulary profile 406 is an example of updating the personal vocabulary profile 406 as described with respect to FIG. 4. Block 530 may be followed by block 526.

In block 526 (“Feedback To Personal Vocabulary Profile”), one or more updates made to the personal vocabulary profile 406, e.g., as described with respect to blocks 522, 528, 533, 534, 538, and 530, may be accomplished by sending one or more corresponding write commands to a memory or storage on which the personal vocabulary profile is stored.

The method 500 may loop as the learner continues reading the electronic document, returning from block 526 to block 504, as denoted by the arrow 540, until the learner finishes reading the electronic document, closes the electronic document, and/or stops providing input for execution of the method 500. Alternately one or more of the operations of the method 500 of FIG. 5 may be repeated and/or omitted for different terms encountered by the learner as the learner reads the electronic document.

FIG. 6 shows an example flow diagram of a method 600 to estimate a current level of vocabulary knowledge of the learner, arranged in accordance with at least one implementation described herein. As such, FIG. 6 illustrates an example implementation of block 412 of FIG. 4. The method 600 may be implemented, in whole or in part, by one or more of the learner devices 104 or vocabulary server 106 of FIG. 1, the system 200 of FIG. 2, or another suitable device, server, and/or system. For example, in some implementations, some or all of the method 600 of FIG. 6 may be performed by the estimation module 228 of FIG. 2 being executed on a suitable device, server, and/or system.

The estimation of the current level of vocabulary knowledge of the learner may be implemented using a personal vocabulary profile 602 of the learner and/or one or more vocabulary databases each of a particular level (hereinafter “vocabulary database” or “vocabulary databases”) 604. The personal vocabulary profile 602 may be included in or correspond to the personal vocabulary profiles 124 of FIG. 1, the personal vocabulary profiles 222 of FIG. 2, the personal vocabulary profile 300 of FIG. 3, the personal vocabulary profile 406 of FIGS. 4-5A, or other personal vocabulary profiles described herein. The vocabulary database 604 may correspond to or include the vocabulary database 108 of FIG. 1, the vocabulary database 414 of FIG. 4, or other vocabulary databases described herein. The method 600 may begin at block 606.

In block 606, unstable terms and stable terms in the personal vocabulary profile 602 may be identified that are also in the vocabulary database 604 of the particular level. The vocabulary database 604 may include a total number of terms N. Block 606 may be followed by block 608.

In block 608, a first number S of the identified stable terms may be calculated. For example, in some implementations, the number of stable terms from the personal vocabulary profile 602 that are identified as also being in the vocabulary database 604 may be counted to calculate the first number S. Block 608 may be followed by block 610.

In block 610, a discounted second number U of the identified unstable terms may be calculated. For example, in some implementations, confidence values C of the unstable terms from the personal vocabulary profile 602 that are identified as also being in the vocabulary database 604 may be summed and the sum may be divided by the counter threshold value M_C to calculate the discounted second number U. Block 610 may be followed by block 612.

In block 612, a coverage of the identified stable and unstable terms with respect to the vocabulary database 604 may be calculated. The calculation of the coverage with respect to the vocabulary database 604 may be based on the total number of terms N in the vocabulary database, the first number S, and the discounted second number U. For example, the coverage may be calculated as (S+U)/N. It may be seen from blocks 608, 610, and 612 and the calculations involved therein that each stable term that is included in the vocabulary database 604 may generally contribute equally to the calculated coverage, while each unstable term that is included in the vocabulary database 604 may contribute a discounted amount to the calculated coverage, where the discounted amount contributed by each unstable term increases with increasing confidence value C. Block 612 may be followed by block 614.

In block 614, it may be determined whether the coverage exceeds a coverage threshold value. The determination may be made by comparing the calculated coverage to the coverage threshold value and determining which is greater. Block 614 may be followed by block 616 (“Yes” at block 614) or by block 618 (“No” at block 614).

In block 616, and responsive to a determination that the calculated coverage exceeds the coverage threshold value, it may be determined that the current level of vocabulary knowledge of the learner is at least at the particular level, which may be thereafter referred to as the estimated current level of vocabulary knowledge of the learner. In some implementations, and each time the current level of vocabulary knowledge of the learner is determined to be at least the particular level, the method 600 may repeat using a vocabulary database of a higher level (e.g., greater difficulty) until the calculated coverage does not exceed the coverage threshold value. In these and other implementations, the highest level of vocabulary database for which the calculated coverage exceeds the coverage threshold value may be determined as the current level of vocabulary knowledge of the learner.

In block 618, and responsive to a determination that the calculated coverage does not exceed the coverage threshold value, it may be determined that the current level of vocabulary knowledge of the learner is below the particular level. In some implementations, and each time the current level of vocabulary knowledge of the learner is determined to be below the particular level, the method 600 may repeat using a vocabulary database of a lower level (e.g., less difficult) until the calculated coverage exceeds the coverage threshold value. In these and other implementations, the level of vocabulary database for which the calculated coverage exceeds the coverage threshold value may be determined as the current level of vocabulary knowledge of the learner.

FIG. 7 shows an example flow diagram of a method 700 to identify and recommend one or more vocabulary terms to learn to a learner, arranged in accordance with at least one implementation described herein. As such, FIG. 7 illustrates an example implementation of block 416 of FIG. 4. The method 700 may be implemented, in whole or in part, by one or more of the learner devices 104 or vocabulary server 106 of FIG. 1, the system 200 of FIG. 2, or another suitable device, server, and/or system. For example, in some implementations, some or all of the method 700 of FIG. 7 may be performed by the recommendation module 230 of FIG. 2 being executed on a suitable device, server, and/or system.

The identification and recommendation of the one or more vocabulary terms to learn may be implemented using personal vocabulary profiles 702 and/or one or more vocabulary databases each of a particular level (hereinafter “vocabulary database” or “vocabulary databases”) 704. The personal vocabulary profiles 702 may include a personal vocabulary profile of a particular learner and of other learners. The particular learner may be referred to hereinafter as “the learner,” while the learner and the other learners may be collectively referred to hereinafter as “the learners.” The personal vocabulary profiles 702 may include or correspond to the personal vocabulary profiles 124 of FIG. 1, the personal vocabulary profiles 222 of FIG. 2, the personal vocabulary profile 300 of FIG. 3, the personal vocabulary profile 406 of FIGS. 4-5A, the personal vocabulary profile 602 of FIG. 6, or other personal vocabulary profiles described herein. The vocabulary database 704 may correspond to or include the vocabulary database 108 of FIG. 1, the vocabulary database 414 of FIG. 4, the vocabulary database 604 of FIG. 6, or other vocabulary databases described herein. The method 700 may begin at block 706.

In block 706, a topic model analysis of a reading corpus may be performed to identify topics covered in the reading corpus. The reading corpus may include all or at least some of the electronic documents read by the learners. Block 706 may be followed by one or both of blocks 708 and 710, each of which will be discussed in turn.

In block 708, one or more of the topics identified by the topic model analysis may be assigned to each of one or more of the terms in the vocabulary database 704. The vocabulary database 704 in some implementations is at the same level as an estimated current level of vocabulary knowledge 718 of the learner. Alternatively, the vocabulary database 704 is at a different level than the estimated current level of vocabulary knowledge 718 of the learner. Alternatively, the vocabulary database 704 includes multiple different levels, up to all levels, each level of which may individually be at the same level as or at a different level than the estimated current level of vocabulary knowledge 718 of the learner.

The estimated current level of vocabulary knowledge 718 may be estimated as generally described with respect to FIG. 6. Assigning one or more of the topics to each of the one or more terms in the vocabulary database 704 may generate topic distributions 712 for the corresponding terms in the vocabulary database 704. Each topic distribution 712 may identify, for a corresponding term in the vocabulary database 704, one or more of the topics identified by the topic model analysis that include the corresponding term. As an example, the topic distribution 712 may identify, for a term X in the vocabulary database 704, a first topic Y in which the term X appears with a probability of A (e.g., 80%), and a second topic Z in which the term X appears with a probability of B (e.g., 20%). Block 708 may be followed by block 714, which will be discussed further below.

In block 710, a subset of the topics covered in the electronic documents read by the learner, or in at least some of the electronic documents read by the learner, may be identified. The identified subset of topics may be referred to as “learner's topic distribution 716.” As an example, the learner's topic distribution 716 may include topics A, B, and C, and corresponding percentages of X, Y, and Z. Block 710 may be followed by block 714.

In block 714, one or more vocabulary terms to recommend to the learner to learn may be determined. The determination may be based on the topic distributions 712, the learner's topic distribution 716, the estimated current level of vocabulary knowledge 718 of the learner, and/or learner preferences 720 that may be included in the learner's personal vocabulary profile. In some implementations, the one or more vocabulary terms to recommend may be determined from the vocabulary database 704. Alternately or additionally, the one or more vocabulary terms to recommend to the learner may be categorized in an appropriate vocabulary level for the learner. In some implementations, “an appropriate vocabulary level” may include a vocabulary level that is the same as or a little higher (e.g., up to several levels higher) than the estimated current level of vocabulary knowledge 718 of the learner. If consistent with the learner's preferences 720, the vocabulary terms to learn may include vocabulary terms that are related, or not, to topics of interest of the user or to topics included in the learner's topic distribution 716. A vocabulary term may be considered as related to a particular topic (e.g., to a topic of interest or to a topic included in the learner's topic distribution) if the topic distribution of the vocabulary term includes the particular topic. A topic percentage of a term can also be considered in the recommendation of one or more vocabulary terms to the learner, such as a topic percentage of 70% for the term “bank” with respect to a “finance” topic, a topic percentage of 15% with respect to a “medicine” topic (e.g., “blood bank” and/or “gene bank”), and a topic percentage of 15% with respect to a “natural geography” topic (e.g., “river bank”). Accordingly, in some implementations and based on the learner's preferences 720, a topic distribution of a vocabulary term to recommend may include at least one topic in common with a topic included in the learner's topic distribution 716. Block 714 may be followed by block 722.

In block 722, the one or more vocabulary terms to learn may be recommended to the learner.

The implementations described herein may include the use of a special purpose or general purpose computer including various computer hardware or software modules, as discussed in greater detail below.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present inventions have been described in detail, it should be understood that the various changes, substitutions, and alterations could be made hereto without departing from the spirit and scope of the invention.

What is claimed is:

1. A method to build a learner's vocabulary, the method comprising:
accessing a personal vocabulary profile of a learner from a non-transitory computer-readable medium, wherein the personal vocabulary profile includes one or more unstable terms and one or more stable terms, the one or more unstable terms comprise one or more terms being learned by the learner, and the one or more stable terms comprise one or more terms that have been mastered by the learner;
marking a term in an electronic document output to a display device as an unstable term in response to the term in the electronic document being included in the one or more unstable terms of the personal vocabulary profile;
receiving input effective to indicate whether the learner understands the term marked as the unstable term;
determining whether the learner understands the term marked as the unstable term based on the received input; and
updating the personal vocabulary profile in the non-transitory computer-readable medium to indicate whether the learner understands the term marked as the unstable term.

2. The method of claim 1, wherein the term marked as the unstable term comprises a first term, the method further comprising:
receiving input effective to identify a second term in the electronic document as not understood by the learner;
providing an explanation of the second term to the learner; and
adding the second term to the one or more unstable terms of the personal vocabulary profile.

3. The method of claim 2, further comprising:
extracting, from the electronic document, a first context sentence that includes the first term;
extracting, from the electronic document, a second context sentence that includes the second term;
adding the first context sentence and the second context sentence to the personal vocabulary profile;
in response to receiving input effective to request an explanation of the first term or the second term in a second electronic document that includes at least one of the first term and the second term, providing a second explanation that includes the first context sentence or the second context sentence as an example sentence of the first term or the second term in context.

4. The method of claim 2, wherein providing the explanation of the second term to the learner comprises providing to the learner at least one of: a definition of the second term; a translation of the second term, or a sentence that includes the second term in context.

5. The method of claim 1, wherein:
updating the personal vocabulary profile in the non-transitory computer-readable medium to indicate whether the learner understands the term marked as the unstable term comprises:
zeroing out a confidence value included in the personal vocabulary profile and associated with the unstable term in response to determining that the learner does not understand the term marked as the unstable term; or
incrementing the confidence value in response to determining that the learner understands the term marked as the unstable term; and
the method further comprises, in response to the confidence value reaching a counter threshold value, changing the unstable term in the personal vocabulary profile to a stable term in the personal vocabulary profile.

6. The method of claim 1, further comprising:
marking a plurality of terms in the electronic document as unstable terms in response to the plurality of terms in the electronic document being included in the one or more unstable terms of the personal vocabulary profile;
generating an index that includes each of the plurality of terms that are marked as unstable terms in the electronic document; and
in response to receiving input effective to select one of the plurality of terms in the index, at least one of:
navigating to a sentence of the electronic document that includes the selected one of the plurality of terms; and
providing to the learner an explanation of the selected one of the plurality of terms.

7. The method of claim 1, further comprising:
estimating a current level of vocabulary knowledge of the learner; and
recommending to the learner one or more vocabulary terms to learn, wherein the recommended one or more vocabulary terms to learn are determined based on the estimated current level of vocabulary knowledge.

8. The method of claim 7, wherein estimating the current level of vocabulary knowledge comprises:
identifying a plurality of terms in the one or more unstable terms and the one or more stable terms of the personal vocabulary profile that are also in a vocabulary database of a particular level of vocabulary knowledge, wherein the vocabulary database includes a total number of terms;
calculating a first number of the identified plurality of terms that are included in the one or more stable terms;
calculating a discounted second number of the identified plurality of terms that are included in the one or more unstable terms;
calculating a coverage of the identified plurality of terms with respect to the vocabulary database based on the total number of terms in the vocabulary database, the first number, and the discounted second number; and
one of:
when the calculated coverage is above a coverage threshold value, determining that the current level of vocabulary knowledge of the learner is at least the particular level; or
when the calculated coverage is below the coverage threshold value, determining that the current level of vocabulary knowledge of the learner is below the particular level.

9. The method of claim 7, further comprising, prior to recommending to the learner the one or more vocabulary terms to learn:
performing a topic model analysis of a reading corpus that includes a plurality of electronic documents read by a plurality of learners to identify a plurality of topics covered in the reading corpus;
assigning one or more of the plurality of topics to each of a plurality of vocabulary terms in a vocabulary database to generate a plurality of topic distributions, wherein each of the plurality of vocabulary terms has a corresponding topic distribution;
identifying a subset of the plurality of topics covered in a subset of the plurality of electronic documents read by the learner; and
determining the recommended one or more vocabulary terms to learn based on the estimated current level of vocabulary knowledge, the identified subset of the plurality of topics, and the plurality of topic distributions,
wherein the recommended one or more vocabulary terms to learn include one or more of the plurality of vocabulary terms, and wherein at least one of:
each of the one or more of the plurality of vocabulary terms is categorized in the estimated current level of vocabulary knowledge; and
a topic distribution of each of the one or more of the plurality of vocabulary terms has at least one topic in common with the identified subset of the plurality of topics.

10. The method of claim 1, further comprising generating a report displayed on the display device to the learner, wherein the report includes at least one of:
a ranking, by repeated learning time for the learner, of terms;
a ranking, by repeated learning time for the learner, of terms in the personal vocabulary profile of the learner;
a ranking, by repeated learning time across a plurality of learners, of terms in a plurality of personal vocabulary profiles of the plurality of learners; and
a ranking, by vocabulary coverage rate, of the learner with respect to others of the plurality of learners.

11. A system to build a learner's vocabulary, the system comprising:
a profile module configured to access a personal vocabulary profile of a learner, wherein the personal vocabulary profile includes one or more unstable terms and one or more stable terms, the one or more unstable terms comprise one or more terms being learned by the learner, and the one or more stable terms comprise one or more terms that have been mastered by the learner; and
a vocabulary learning module configured to:
mark a term in an electronic document output to a display device as an unstable term in response to the term in the electronic document being included in the one or more unstable terms of the personal vocabulary profile;
receive input effective to indicate whether the learner understands the term marked as the unstable term; and
determine whether the learner understands the term marked as the unstable term based on the received input,
wherein the profile module is further configured to update the personal vocabulary profile to indicate whether the learner understands the term marked as the unstable term.

12. The system of claim 11, further comprising:
an electronic document reader communicatively coupled to the profile module and the vocabulary learning module and configured to render the electronic document;
the display device coupled to the electronic document reader, wherein the rendered electronic document is displayed to the learner on the display device;
a processor device communicatively coupled to the display device; and
a non-transitory computer-readable medium communicatively coupled to the processor device, wherein:
the non-transitory computer-readable medium has encoded therein the electronic document reader, the profile module, and the vocabulary learning module; and
the electronic document reader, the profile module, and the vocabulary learning module comprise programming code executable by the processor device.

13. The system of claim 11, wherein:
the term marked as the unstable term comprises a first term;
the vocabulary learning module is further configured to:
receive input effective to identify a second term in the electronic document as not understood by the learner;
provide an explanation of the second term to the learner; and
the profile module is further configured to add the second term to the one or more unstable terms of the personal vocabulary profile.

14. The system of claim 13, wherein:
the vocabulary learning module is further configured to:
extract, from the electronic document, a first context sentence that includes the first term;
extract, from the electronic document, a second context sentence that includes the second term;
the profile module is further configured to add the first context sentence and the second context sentence to the personal vocabulary profile; and
in response to receipt of input effective to request an explanation of the first term or the second term in a second electronic document that includes at least one of the first term and the second term, the vocabulary learning module is further configured to provide a second explanation that includes the first context sentence or the second context sentence as an example sentence of the first term or the second term in context.

15. The system of claim 13, wherein the vocabulary learning module is configured to provide the explanation of the second term to the learner by provision to the learner of at least one of: a definition of the second term; a translation of the second term, or a sentence that includes the second term in context.

16. The system of claim 11, wherein:
the profile module is configured to update the personal vocabulary profile to indicate whether the learner understands the term marked as the unstable term by:
zeroing out a confidence value included in the personal vocabulary profile and associated with the unstable term in response to a determination by the vocabulary learning module that the learner does not understand the term marked as the unstable term; or
incrementation of the confidence value in response to a determination by the vocabulary learning module that the learner understands the term marked as the unstable term; and
the profile module is further configured, in response to incrementation of the confidence value to a counter threshold value, to change the unstable term in the personal vocabulary profile to a stable term in the personal vocabulary profile.

17. The system of claim 11, wherein the vocabulary learning module is further configured to:
mark a plurality of terms in the electronic document as unstable terms in response to the plurality of terms in the electronic document being included in the one or more unstable terms of the personal vocabulary profile;
generate an index that includes each of the plurality of terms that are marked as unstable terms in the electronic document; and
in response to receipt of input effective to select one of the plurality of terms in the index, at least one of:
navigate to a sentence of the electronic document that includes the selected one of the plurality of terms; and
provide to the learner an explanation of the selected one of the plurality of terms.

18. The system of claim 11, further comprising:
an estimation module configured to estimate a current level of vocabulary knowledge of the learner; and
a recommendation module configured to recommend to the learner one or more vocabulary terms to learn, wherein the recommended one or more vocabulary terms to learn are determined based on the estimated current level of vocabulary knowledge.

19. The system of claim 18, wherein the estimation module is configured to estimate the current level of vocabulary knowledge by:
identification of a plurality of terms in the one or more unstable terms and the one or more stable terms of the personal vocabulary profile that are also in a vocabulary database of a particular level of vocabulary knowledge, wherein the vocabulary database includes a total number of terms;
calculation of a first number of the identified plurality of terms that are included in the one or more stable terms;
calculation of a discounted second number of the identified plurality of terms that are included in the one or more unstable terms;
calculation of a coverage of the identified plurality of terms with respect to the vocabulary database based on the total number of terms in the vocabulary database, the first number, and the discounted second number; and
one of:
when the calculated coverage is above a coverage threshold value, a determination that the current level of vocabulary knowledge of the learner is at least the particular level; or
when the calculated coverage is below the coverage threshold value, a determination that the current level of vocabulary knowledge of the learner is below the particular level.

20. The system of claim 11, further comprising an analysis and report module configured to generate a report that includes at least one of:
a ranking, by repeated learning time for the learner, of terms;
a ranking, by repeated learning time for the learner, of terms in the personal vocabulary profile of the learner;
a ranking, by repeated learning time across a plurality of learners, of terms in a plurality of personal vocabulary profiles of the plurality of learners; and
a ranking, by vocabulary coverage rate, of the learner with respect to others of the plurality of learners.
